(19) United States
(12) Patent Application Publication
(10) Pub. No.: US 2005/0219158 A1
(43) Pub. Date: Oct. 6, 2005

(54) Plasma display and method for driving the same

(75) Inventors: Takatoshi Shoji, Izumi (JP); Shinji Hirakawa, Izumi (JP); Shinya Tsuchida, Izumi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER PLASMA DISPLAY CORPORATION

(21) Appl. No.: 11/083,072

(22) Filed: Mar. 18, 2005

(30) Foreign Application Priority Data
Mar. 18, 2004 (JP) 2004-078919

(51) Int. Cl. G09G 3/28

(52) U.S. Cl. 345/63

(57) ABSTRACT

A plasma display device in which, regardless of whether the display data amount is large or small, the variances in the luminance can be suppressed, the gradation of the display data can be faithfully displayed, the display quality is excellent, the power consumption is small, and a method of driving the plasma display device. A subfield-by-subfield display load calculating part calculates display load amount allocated to the respective subfields from the display data with respect to each of the subfields. Based on the calculated data of the display load amount, a sustain frequency calculating part calculates optimum sustain frequencies for the respective subfields. A sustain frequency controller within a drive controller generates sustain pulse voltage data based on the sustain frequencies calculated with respect to each of the subfields.

### BACKGROUND OF THE INVENTION

1. Field of the Invention

This invention relates to an AC discharge type plasma display and a method for driving the same, and more particularly to compensating for variances in luminance due to the display load on a sustain pulse drive circuit of a memory-type plasma display device.

2. Description of the Related Art

Plasma display panels (hereinafter referred to as PDPs) have many advantages such as a thin profile, a flickering-free feature, a large display contrast ratio, the ability to provide relatively large screens, a fast response speed, the selfluminous characteristic, the ability to emit multiple colors by use of fluorescent materials, and the like. For this reason, in recent years PDPs are widely used in the field of computer-related display devices, and the field of color image display devices such as home-use thin-shaped television sets.

The PDPs are classified into an AC discharge type and a DC discharge type according to their operation modes. The AC discharge type has electrodes which are coated with a dielectric material, and operates in the state of indirect AC discharge. The DC discharge type has electrodes which are exposed to the discharge space, and operates in the state of DC discharge. The AC discharge type is further categorized into a memory operation type and a refresh operation type. The memory operation type utilizes a memory function of discharge cells for a drive system, whereas the refresh operation type does not. The luminance of a PDP increases, in principle, in proportion to the frequency of the discharge, i.e. the number of pulse voltages. The refresh operation type is used mainly for PDPs of a small display capacity, because the luminance decreases as the display capacity increases.

FIG. 1 is a cross-sectional view showing a structure of a display cell of an AC discharge memory operation type PDP. This display cell has a glass-made back insulating substrate 801 and a glass-made front insulating substrate 802. On the insulating substrate 802, which is placed on the front of the PDP, are formed a transparent scanning electrode 803 and a transparent sustain electrode 804. On the scanning electrode 803 is formed a trace electrode 805. On the sustain electrode 804 is formed a trace electrode 806. On the insulating substrate 802, the scanning electrode 803, the sustain electrode 804, and the trace electrodes 805 and 806 is provided a dielectric layer 812, so that the scanning electrode 803, the sustain electrode 804, and the trace electrodes 805 and 806 are coated with dielectric layer 812. A protective layer 813 is provided on the dielectric layer 812.

On the insulating substrate 801, which is placed on the back of the PDP, is formed a data electrode 807 to intersect, in a plan view, at right angles with the scanning electrode 803 and the sustain electrode 804. On the insulating substrate 801 and the data electrode 807 is provided a dielectric layer 814. Between the insulating substrates 801 and 802 is provided a partition 809. A discharge gas space 808 formed between the insulating substrates 801 and 802 is filled with a discharge gas of He, Ne, or Xe and the like, or the mixture of these gases. The partition 809 forms this discharge gas space 808 while partitioning display cells. On the dielectric layer 814 and the partition wall 809 is provided a phosphor 811. The phosphor 811 converts ultraviolet rays produced from discharges in the discharge gas into visible rays 810.

Referring to FIG. 1 a discharge operation of a selected display cell will be described. When a pulse voltage greater than a discharge threshold voltage is applied between the scanning electrode 803 and the data electrode 807 to initiate a discharge, positive and negative electric charges are pulled, correspondingly to the polarity of the pulse voltage, to surfaces of the dielectric layers 812 and 814 provided on the front and back sides of the discharge cell, and the electric charges are accumulated. Since an equivalent internal voltage caused by this accumulation of electric discharges, i.e. a wall voltage has a reverse polarity to the pulse voltage, an effective voltage inside the display cell drops with development of the discharge. Therefor, even though the pulse voltage is held at a fixed value, the discharge cannot be sustained and eventually comes to a stop. After that, when a sustain pulse, which is a pulse voltage having the same polarity as that of the wall voltage, is applied between the scanning electrode 803 and the sustain electrode 804, which are adjacent to each other, a voltage of the wall voltage is superimposed on a voltage of the sustain pulse as the effective voltage. Accordingly, even though voltage magnitude of the sustain pulse is small, a sum voltage exceeds the discharge threshold voltage, and the sustain discharge starts again. Thus, the sustain discharge can be sustained by a continuous application of the sustain pulse between the scanning electrode 803 and the sustain electrode 804. This is the memory function mentioned earlier. The sustain discharge can be stopped by applying an erasing pulse either to the scanning electrode 803 or to the sustain electrode 804. The erasing pulse is a low voltage pulse having a wide pulse width that neutralizes the wall voltage, or a pulse having a narrow pulse width that has a similar voltage level as that of the sustain pulse.

Next, a configuration of a conventional PDP drive apparatus will be described. FIG. 2 is a block diagram showing an example of a conventional PDP drive apparatus. A PDP has, on one side of a front insulating substrate, a sustain electrode group 942 and a scanning electrode group 953. The electrode groups 942 and 953 are arranged parallel to each other. On one side of a back insulating substrate which faces the side of the front insulating substrate, is arranged a data electrode group 932. The data electrode group 932 extends so as to intersect at right angles with those electrode groups 942 and 953. At the intersecting point is formed a display cell 922. A sustain electrode X is formed correspondingly and adjacently to respective scanning electrode Y1, Y2, Y3, . . . Yn (where n is any positive integer). One end of the sustain electrode X is connected commonly with each other.

Next, configurations of a plurality of driver circuits for driving the display cell 922 and a control circuit for controlling these driver circuits will be described. There are provided a data driver 931, a sustain electrode driver circuit 940, and a scanning electrode driver circuit 950. The data driver 931 drives data for one line of the data electrode group 953 in order to produce an addressing discharge in the display cell 922. The sustain electrode driver circuit 940 causes a common sustain discharge to the sustain electrode group 942 in order to produce a sustain discharge in the display cell 922. The scanning electrode driver circuit 950 causes a common sustain discharge to the scanning electrode group 953. As shown in FIG. 3 the sustain electrode driver circuit 940 and the scanning electrode driver circuit 950 are respectively equipped with a sustain pulse generating circuit which includes both a clamp circuit 1001 and an electric power recovery circuit 1002, or only a clamp circuit 1001. Furthermore, a scanning driver 955 is provided to sequentially scan the scanning electrodes Y1 to Yn, i.e. the scanning electrode group 953 in order to produce a selective write discharge in an addressing discharge period. The scanning driver 955 applies a sum voltage of a sustain pulse sent from the scanning electrode driver circuit 950 and a voltage supplied from a power supply (not shown) to the scanning electrode group 953 so as to produce a sustain discharge. A control circuit part 961 controls every operation of the data driver 931, the sustain electrode driver circuit 940, the scanning electrode driver circuit 950, the scanning driver 955, and a PDP 921. The main part of the control circuit part 961 is composed of a display data control part 962 and a driving timing control part 963. The display data control part 962 has functions of rearranging externally received display data so as to drive the PDP 921, and temporarily storing the rearranged data row so as to transfer the rearranged data as display data at the time of a sequential scanning by the scanning driver 955 at an addressing discharge. The driving timing control part 963 converts various signals externally received (such as a dot clocks) to internal control signals for driving the PDP 921 and controls the drivers and the driver circuits respectively.

Next, a driving sequence will be described. FIG. 4 shows a plurality of subfields formed in a field by a conventional PDP drive apparatus. For example, the number of subfields into which a field having a period of 16.7 ms is divided is set at eight. By appropriately combining these subfields so as to define the driving sequence, a PDP is able to display with 256 gradation levels. The respective subfields are divided into a scanning period 1101 and a sustain discharge period 1102. In the scanning period 1101, displays data is written corresponding to weight of the respective subfields. In the sustain discharge period 1102, the display data which has been written is displayed. An image of a field is displayed by superimposing the respective subfields.

FIG. 5 shows details of a subfield of a certain weight. Here are shown a sustain electrode driving waveform Wx to be commonly applied to the sustain electrode X, scanning electrode driving waveforms Wyl to Wyn to be applied to scanning electrodes Y1 to Yn, a data electrode driving waveform Wdi (where 1≦i≦k) to be applied to data electrodes D1 to Dk. A subfield period is composed of a scanning period and a sustain discharge period. The scanning period is made up of a preliminary discharge period and a write discharge period. By repeating these scanning period and sustain discharge period a desired image is displayed. It should be noted that the preliminary discharge period is to be provided when needed, and therefore may be omitted.

The preliminary discharge period is provided to generate active particles and wall charges in the discharge gas space so that a stable write discharge can be produced in the write discharge period. In the preliminary discharge period, a preliminary discharge pulse and a preliminary discharge erase pulse are applied. The preliminary discharge pulse causes simultaneous discharges in all the display cells of the PDP. The preliminary discharge erase pulse destroys such wall charges out of the wall charges generated by the application of the preliminary discharge pulse as will inhibit the write discharge and the sustain discharge.

The sustain discharge period is provided to cause sustain discharges in the display cells in which write discharges have been carried out in the write discharge period, and to make those display cells emit light, and thereby to obtain desired luminance.

In the preliminary discharge period, first, a preliminary discharge pulse Pp is applied to the sustain electrode X, and discharges are produced in all of the display cells. Then, a preliminary discharge erase pulse Ppe is applied to the scanning electrodes Y1 to Yn to generate an erase discharge. Thus, the accumulated wall charges are erased by the preliminary discharge erase pulse.

In the subsequent write discharge period, a scanning pulse Pw is sequentially applied to the scanning electrode Y1 to Yn. In addition, a data pulse Pd is selectively applied to the data electrode Di (where i is equal to or greater than 1, and equal to or smaller than k) corresponding to image display data. Thus, write discharges are produced and wall charges are generated in cells to be displayed.

In the subsequent sustain discharge period, only in the display cells in which the write discharges have been produced, sustain discharges are continuously caused by sustain pulses Pc and Ps. A last sustain discharge is caused by a last sustain pulse Pce. After that, the wall charges are erased and the sustain discharge is stopped by a sustain discharge erase pulse Pse. Thus, a light emission operation for a frame is completed.

The operation of the sustain discharge period, which is particularly related to the present invention, will be described in details. As shown in the sustain discharge period of FIG. 5, the sustain discharge operation is realized by alternately applying sustain pulses Ps and Pc to the scanning electrodes and the sustain electrode of the PPD. Therefore, a sustain pulse generating circuit as shown in FIG. 3 is equipped in the scanning electrode driver circuit 950 and the sustain electrode driver circuit 940 respectively. At least one sustain pulse generating circuit is provided commonly to all the scanning electrodes Ya to Yn, and the same holds to the sustain electrode X. As shown in FIG. 3 the sustain pulse generating circuit is composed of the electric power recovery circuit 1002 and the clamp circuit 1001.

FIG. 6 shows a timing chart when a sustain pulse is applied. In FIG. 6, when control signals 1 to 4 are at an H level, respective switches S1 to S4 are switched on.

A sustain discharge period begins when the potential of PDP electrodes is at the ground potential. On a first falling edge of a sustain pulse to a sustain potential (Vs), the switch S1 in FIG. 3 turns off, and subsequently the switch 3 in the electric power recovery circuit turns on. Here, the potential of the PDP electrodes is at the ground potential, and the potential at a capacitor C is approximately at the sustain voltage Vs. Therefore, electric charges move from the PDP panel, which is at the ground potential, to the capacitor C via a recovery coil L, the switch S3, and a diode 3. This movement of the electric charges forms a recovery current. As described above, the recovery current flows, and a displacement to the sustain potential follows. A time period indicated as Trc in FIG. 6 is a half of a resonance period which is determined by values of capacitance of the panel and the capacitor C, and the recovery coil. This is a time period the recovering current flows. After the recovering current flows away, the electrodes are fixed at the sustain potential as the switch 2 turns on.

After the maintenance of the potential of the PDP electrodes at the sustain potential for a predetermined period of time, the potential of the PDP electrodes is raised to the ground potential. First, the switch S2 in a sustain potential clamp circuit is turned off. Then, the switch S4 in the electric power recovery circuit is turned on. Since the capacitor C is approximately at the ground potential, a recovery current flows toward the PDP panel, which is at the sustain voltage Vs, via a diode D4, the switch S4, and the recovery coil L. After the switch S4 is turned on and the recovery current has flowed away, the switch S1 in a ground potential clamp circuit S4 is turned on and the PDP electrodes are fixed at the ground. Then, the switch S4 is turned off. Then after fixing the PDP electrodes at the ground potential for a predetermined period of time once again, the switch S1 is turned off. After that the switch S3 in the electric power recovery circuit is turned on. A recovery current flows and the displacement to the sustain potential Vs begins. By repeating this operation, an application of the sustain pulse is kept on. Because PDPs are capacitive loads, capacitance of a PDP in principle needs to be charged and discharged every time the sustain pulse is applied. Whereas, in the sustain pulse application operation described above, the capacitor C is charged with electric charges with which the panel was once charged. Then, at the next sustain pulse application, the panel is charged with the same electric charges. Thus, charge and discharge power of the panel is recovered and reused.

Thus far, general outlines of the configuration and the operation of a conventional PDP have been explained. Next, problems in conventional methods of driving a PDP and some ways currently proposed to cope with these problems will be described.

In conventional methods of driving a PDP, as shown in FIG. 2, a plurality of display cells are driven by an electrode pair composed of the sustain electrodes X of the sustain electrode group and the respective scanning electrodes Y1 to Yn of the scanning electrode group with respect to each line. In this case, a display current corresponding to display data of each line is approximately in proportion to a total display data amount (load amount) in the display cells. Because resistance components are distributed in the respective electrodes, the longer the electrodes are, the greater resistance values of the electrodes become. Accordingly, the resistance components of the electrodes causes a voltage drop when a display current is supplied, and the amount of voltage drop depends on the amount of the display data. In addition, there exist stray capacitance between the electrodes from the beginning. Due to this stray capacitance, electric charges are unnecessarily accumulated. This also causes a voltage drop.

Furthermore, as shown in FIG. 3, a conventional sustain electrode driver circuit 940 and a conventional scanning electrode driver circuit 950 have a sustain pulse generating circuit which includes both a clamp circuit 1001 and an electric power recovery circuit 1002, or only a clamp circuit 1001. Therefore, every output and the respective control signals are common. As shown in FIG. 6, which is an enlarged view of a portion A of a falling edge of a sustain pulse shown in FIG. 5, points where clamp circuit control signals are turned on are fixed. In this case, a discharge current is always supplied from the clamp circuit. Therefore, similar to the case of the above display current, the amount of discharge current depends on the amount of display data, and causes a voltage drop.

For this reason, when the amount of display data is small, the amount of a voltage drop is small. On the other hand, when the amount of display data is large, the amount of a voltage drop is large. This results in a difference in display luminance between lines. In other words, as indicated by a solid line in the graph of FIG. 7, which illustrates a relationship of luminance against display load amount indicates, when the amount of display data is small, luminance rises more than necessary, and when the amount of display data is large, luminance is decreased. As a result, a problem arises that a gradation display, which must be basically smooth, is disturbed and luminance characteristics becomes discontinuous.

As a technique to cope with this problem, a method as follows is proposed as described in the Japanese Patent No. 2757795 specification (patent document 1). The number of display data is counted. By performing a computation using a predetermined luminance variation coefficient which corresponds to the counted number of display data, the number of sustain discharges necessary to realize desired luminance is obtained. The sustain discharges are stopped after the necessary number of sustain discharges are completed.

A method for obtaining good picture quality through adjusting variances in luminance due to display load is proposed in Japanese Patent Kokai No. 2000-172223 (patent document 2). In this method, the adjustment of the variances in luminance is made by controlling emission intensity per sustain discharge. In this method, in order to control light emission intensity in the respective sustain discharge periods, a time period from the beginning of an electric power recovery to the fixation of the voltage at a sustain potential or the ground potential is made variable, and the time period is adjusted depending on display load.

On the other hand, in an electric power recovery operation, resonance phenomena due to capacitance of a display panel and a capacitor used for electric power recovery operation, or resonance phenomena due to capacitance of a panel and inductance of a recovery coil is utilized. Accordingly, an electric power recovery current which flows through the driver circuit in the electric power recovery operation, keeps flowing for a period which is determined by a half of a resonance period of the above resonance phenomena. In other words, it can be said that this period is a period which is necessary to fully recover reactive power of the plasma display, or a capacitive load. In FIG. 6, a period indicated by Trc corresponds to this period.

In the method described in the patent document 2, since a time period from the beginning of an electric power recovery to the fixation of the voltage at a sustain potential or the ground potential is made variable, there can be cases where the time period is shorter than a time period which is necessary to recover the power. In FIG. 8, a voltage waveform and a current waveform in the case time points to fix a sustain pulse voltage at a sustain potential and the ground potential are set at time points Tcs1 and Tcg1, are represented by solid lines. At the time points Tcs1 and Tcg1, an electric power recovery operation is completed. A voltage waveform and a current waveform in the case time points to be fixed at the sustain potential and the ground potential is set at a time point Tcs2 or Tcg2, are shown in dashed lines. At the time points Tcs2 and Tcg2, an electric power recovery operation has not completed. In FIG. 8, an electric power recovery operation starts at time points Trc or Trs.

As shown in FIG. 8, when time points to fix a sustain pulse voltage at a sustain potential and the ground potential is set at Tcs2 and Tcg2, the amount of an electric current passes through the clamp circuit is increased compared to a case where the time points to fix a sustain pulse voltage at a sustain potential and the ground potential is set at Tcs1 and Tcg1. This is because a displacement current of panel capacitance is passed from the clamp circuit before the electric power recovery operation is completed. When time points to fix a sustain pulse voltage at a sustain potential and the ground potential are fixed at Tcs1 and Tcg1, electric charges charged into the panel capacitance at the application of a previous sustain pulse is reused at the next application of a sustain pulse, and therefore reactive power can be reduced. On the other hand, when time points to fix a sustain pulse voltage at a sustain potential and the ground potential are fixed at Tcs2 and Tcg2, potentials of the sustain pulse voltage are fixed at the clamp circuit before the electric charges of the previous sustain pulse are sufficiently charged, and therefore all the electric charges which should be reused become reactive power.

However, the display devices disclosed in the patent documents 1 and 2 have some problems.

According to the method disclosed in the patent document 1, it is possible to set the number of the sustain discharges to realize desired luminance with respect to subfields which have frequent sustain discharges. However, because corrected number of the sustain discharges is to be obtained in an integer, it is impossible to set the number of the sustain discharges to realize desired luminance with respect to subfields which have infrequent sustain discharges.

According to the method disclosed in the patent document 2, as already described, since the time period from the beginning of an electric power recovery to the fixation at a sustain potential and the ground potential is made variable, there arises a problem that an electric power recovery rate is decreased, reactive power is increased, and thereby power consumption is increased. The reactive power does not contribute to light emission of a plasma display panel at all, but contribute to the increase of power consumption. Furthermore, heat generation also increases, and this requires countermeasures such as reinforcement of a cooling structure and increasing the number of parallel-connected elements in order to reduce the resistance components in the circuit. As a result cost is boosted.

The method disclosed in the patent document 2 has another problem as follows. When the time period from the beginning of an electric power recovery to the fixation of the potentials of the scanning electrodes and the sustain electrodes of a PDP at a sustain potential and the ground potential is shorter than the time period necessary for the electric power recovery, as shown by dashed lines in FIG. 8, there is a great difference between the potentials at the time points when the potentials of the scanning electrodes and the sustain electrodes are fixed at the sustain potential and the ground potential, and a sustain potential and the ground potential. Thus, amount of displacement by the clamp circuit, which clamps a voltage at a fixed potential, is increased. Here, a peak value of the displacement current rises with the increase in the displacement amount, and an overshoot and an undershoot occur because of parasitic inductance of the driver circuit. By this, potential difference to be applied between the sustain electrodes becomes greater than potential difference of the sustain potential and the ground potential themselves. Then, the potential difference exceeds an erroneous discharge voltage (a discharge start voltage in non-selected cells) of the PDP, and discharges occur in non-selected cells. Since these discharges are not according to display data, picture quality is degraded.

### SUMMARY OF THE INVENTION

The present invention was made in view of the foregoing problems, and it is an object of the present invention to provide a plasma display device which can control the variances in luminance and display gradation faithfully to the display data, and which is excellent in picture quality and needs little electricity to work and a method of driving the same.

According to a first aspect of the present invention, there is provided a plasma display device which includes a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, a first processing part which converts an image signal into display data to be displayed on a plasma display panel with respect to each of the display cells, and allocates the display data to respective subfields which constitutes a field of a display period, a second processing part which calculates display load amount for the respective subfields based on the display data allocated to each of the subfields with respect to the respective display cells, a third processing part which calculates a sustain frequency of a sustain pulse to be applied in periods of the respective subfields based on the display load amount for the respective subfields, a sustain frequency controller which generates a sustain pulse waveform to be applied to the respective subfields based on the sustain frequency of the sustain pulse to be applied in the periods of the respective subfields, and a drive controller which supplies the sustain pulse waveform to the scanning electrode driver and the sustain electrode driver.

The first processing part converts an image signal into display data to be displayed on a plasma display panel with respect to each of the display cells, and allocates the display data to respective subfields which constitutes a field of a display period. The second processing part calculates display load amount for the respective subfields based on the display data allocated to each of the subfields with respect to the respective display cells. The third processing part calculates a sustain frequency of a sustain pulse to be applied in periods of the respective subfields based on the display load amount for the respective subfields. Based on the sustain frequency of the sustain pulse, the sustain frequency controller generates a sustain pulse waveform with respect to each of the subfields. The drive controller supplies the sustain pulse waveform to the scanning electrode driver and the sustain electrode driver. Accordingly, a pulse having an optimum sustain frequency for each of the respective subfields is applied to the respective display cells.

Preferably the third processing part calculates the sustain frequency of the sustain pulse based on sustain waveform data per sustain frequency at the time of discharges produced in the display cells. The third processing part may calculate the sustain frequency of the sustain pulse based on data of a relationship between sustain frequencies of sustain pulses and display load amount prestored in a storage element.

According to a second aspect of the present invention, there is provided a plasma display device which includes a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, an electric power recovery circuit for generating a sustain pulse whose inductance is changeable, a first processing part which converts an image signal into display data to be displayed on a plasma display panel with respect to each of the display cells, and allocates the display data to respective subfields which constitutes a field of a display period, a second processing part which calculates display load amount for the respective subfields based on the display data allocated to each of the subfields with respect to the respective display cells, and a control circuit having a function of changing the inductance of the electric power recovery circuit.

The first processing part converts an image signal into display data to be displayed on a plasma display panel with respect to each of the display cells, and allocates the display data to respective subfields which constitutes a field of a display period. The second processing part calculates display load amount for the respective subfields based on the display data allocated to each of the subfields with respect to the respective display cells. The control circuit changes the inductance of the electric power recovery circuit based on the display amount for the respective subfields. Therefore, luminance per cycle of a sustain pulse can be controlled, and display quality can be improved.

The electric power recovery circuit may include a plurality of coils having different inductances, and select and use one or more than two of the coils.

Preferably the plasma display device includes one or two clamp circuit(s).

Preferably the second processing part calculates display load amount for the respective subfields with respect to each line of the sustain electrodes. The second processing part may calculate display load amount for the respective subfields with respect to plural lines of the sustain electrodes. The second processing part may calculate display load amount for in the respective subfields as a sum of display load amount of all lines of the sustain electrodes.

According to a third aspect of the present invention, there is provided a method of driving a plasma display device which includes a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, wherein the method includes a first step for converting an image signal into display data to be displayed on a plasma display panel with respect to each of the display cells, and allocating the display data to respective subfields which constitutes a field of display period, a second step for calculating display load amount for the respective subfields based on the display data allocated to each of the subfields with respect to the respective display cells, a third step for calculating a sustain frequency of a sustain pulse to be applied in periods of the respective subfields based on the display load amount for the respective subfields, a fourth step for generating a sustain pulse waveform to be applied to the respective subfields based on the sustain frequency of the sustain pulse to be applied in the periods of the respective subfields, and a fifth step for supplying the sustain pulse waveform to the scanning electrode driver and the sustain electrode driver.

Preferably the third step is a step for calculating the sustain frequency of the sustain pulse based on sustain waveform data per sustain frequency at the time of discharges produced in the display cells. In the third step, the sustain frequency of the sustain pulse can be calculated based on data of a relationship between sustain frequencies of sustain pulses and display load amount prestored in a storage element.

According to a fourth aspect of the present invention, there is provided a method of driving a plasma display device which includes a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, an electric power recovery circuit for generating a sustain pulse whose inductance is changeable, wherein the method include a first step for converting an image signal into display data to be displayed on a plasma display panel with respect to each of the display cells, and allocating the display data to the respective subfields which constitutes a field of display period, a second step for calculating display load amount for the respective subfields based on the display data allocated to each of the subfields with respect to the respective display cells, a third step for changing the inductance of the electric power recovery circuit based on the display load amount for the respective subfields.

The electric power recovery circuit may includes a plurality of coils having different inductances, and the third step may be a step in which one or more than two of the coils of the electric power recovery circuit are selected and used.

Preferably the second step is a step in which display load amount for the respective subfields is calculated with respect to each line of the sustain electrodes. The second step may be, for example, a step in which display load amount for the respective subfields is calculated with respect to plural lines of the sustain electrodes. Furthermore, the second step is a step in which display load amount for the respective subfields calculated as a sum of display load amount of all lines of the sustain electrodes.

According to any of the first to the fourth aspects of the present invention, luminance per cycle of a sustain pulse can be adjusted correspondingly to display load amount. Therefore, variances in luminance due to differences in the display load amount can be suppressed.

According to the first and the third aspects of the present invention, since the frequency of the sustain pulse is changed correspondingly to the display load amount, variances in luminance due to differences in the display load amount can be suppressed. According to the second and the fourth aspects of the present invention, since the inductance of the electric power recovery circuit within the drive controller of the sustain pulse is changed correspondingly to the display load amount, variances in luminance due to differences in the display load amount can be suppressed.

In the following, embodiments of the present invention will be described in detail with reference to the drawings. FIG. 9 is a block diagram of a first embodiment of the present invention. An image processing part 101 converts a received image signal into a signal to be displayed on a plasma display panel, while performing an operation to calculate frequencies of sustain pulses in respective subfields. The image processing part 101 has a subfield control part 102, a subfield-by-subfield display load calculating part 103, and a sustain frequency calculating part 104. The subfield control part 102 converts an image signal into data for the respective subfields to be displayed on a plasma display panel. From the data allocated to the respective subfields, the subfield-by-subfield display load calculating part 103 calculates display load amount allocated to the respective subfields. Based on the data of the display load amount, the sustain frequency calculating part 104 calculates optimum sustain frequencies for the respective subfields. A sustain frequency controller 106 within a drive controller 105 generates a sustain pulse waveform based on the sustain frequencies for the respective subfields. The drive controller 105 supplies the sustain pulse waveform based on the sustain frequencies for the respective subfields generated in the sustain frequency controller 106 to a scanning electrode driver 107 and a sustain electrode driver 108, and drives the scanning electrode driver 107 and the sustain electrode driver 108. The scanning electrode driver 107 and the sustain electrode driver 108 apply the sustain pulse waveform to the plasma display panel based on the received sustain pulse waveform.

### BRIEF DESCRIPTION OF THE DRAWINGS

FIG. 1 is a cross-sectional view showing a structure of a display cell of an AC discharge memory-type PDP.

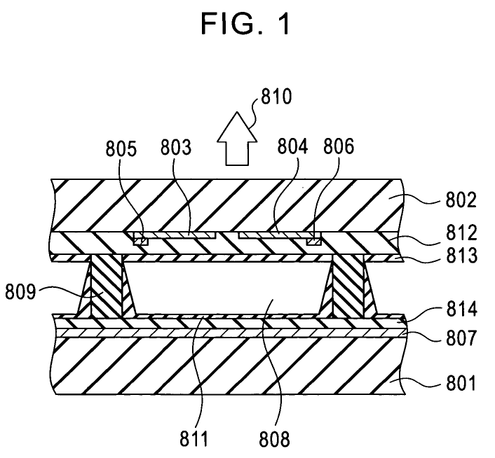

FIG. 2 is a block diagram showing an example of a conventional PDP drive apparatus.

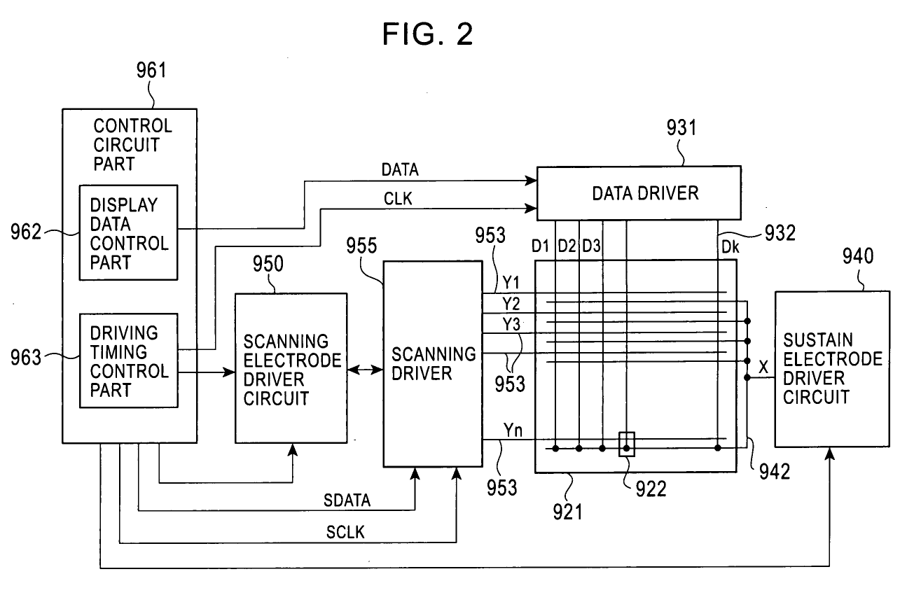

FIG. 3 is a circuit diagram of a sustain pulse generating circuit.

FIG. 4 shows a plurality of subfields formed by a conventional PDP drive apparatus.

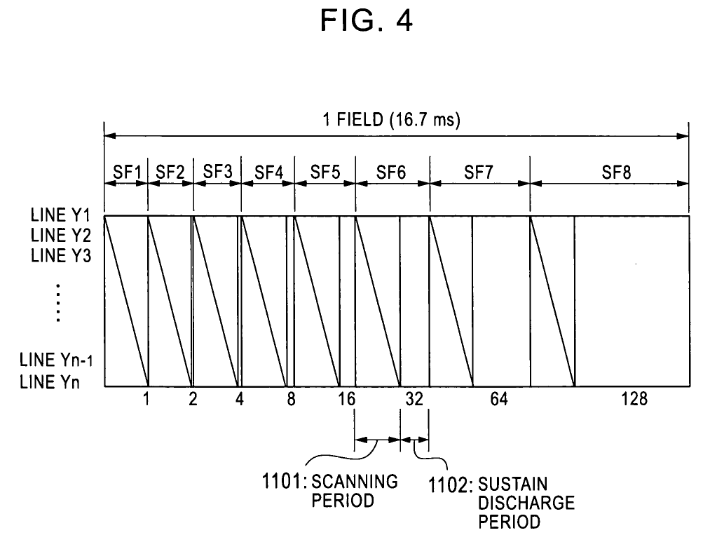

FIG. 5 shows details of a subfield having a certain weight.

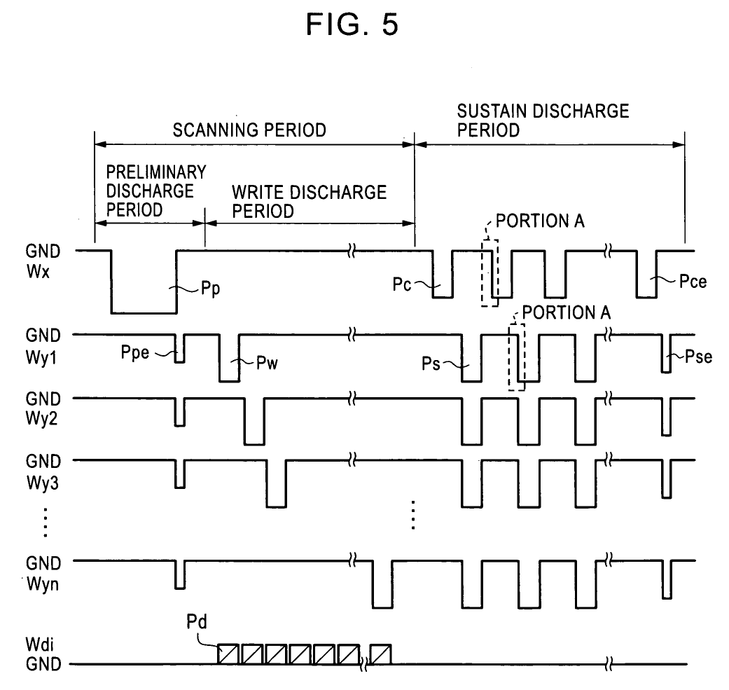

FIG. 6 is a timing chart at the time of applying a sustain pulse.

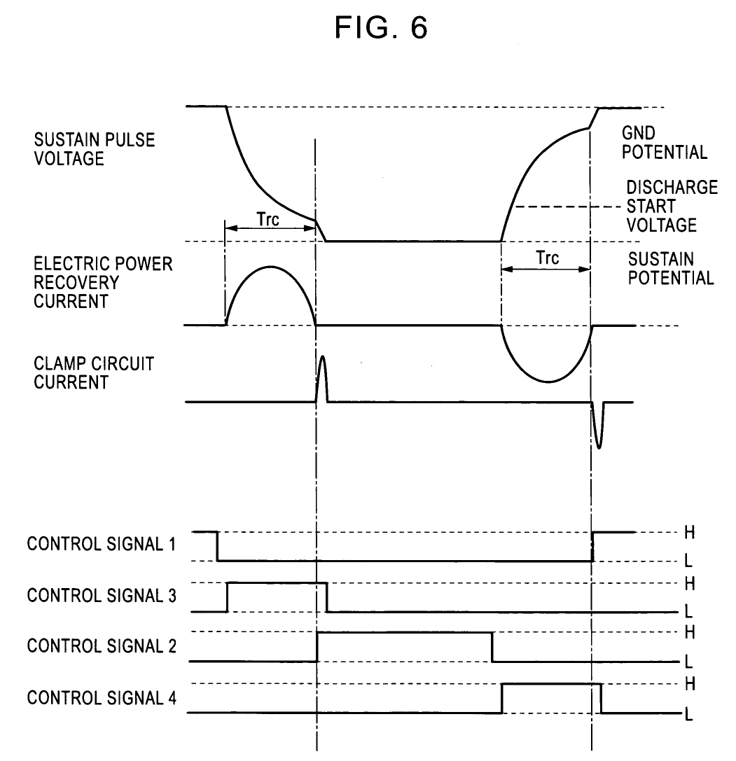

FIG. 7 is a graph showing a relationship between display load amount and luminance.

FIG. 8 is a timing chart at the time of applying a sustain pulse.

FIG. 9 is a block diagram of a first embodiment.

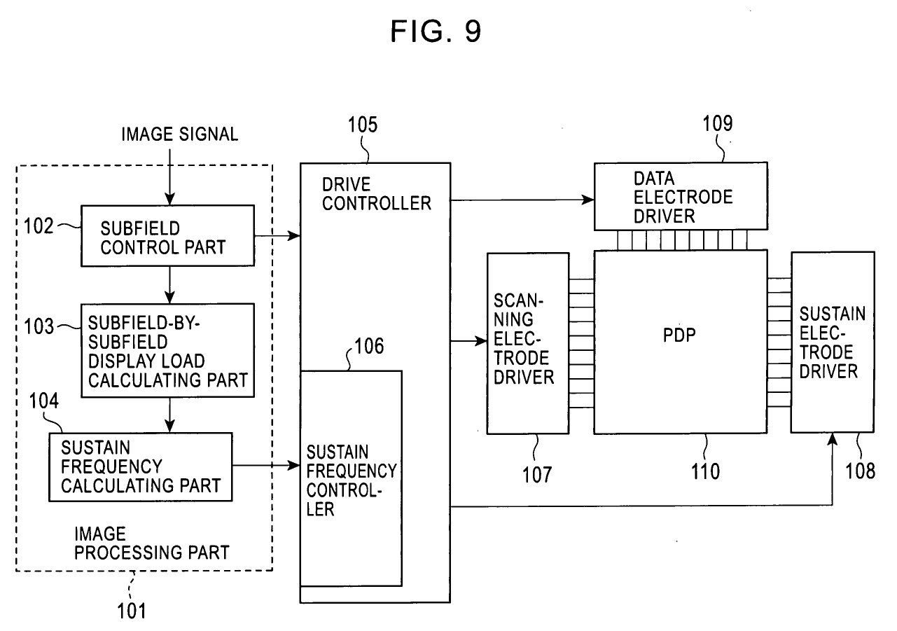

FIG. 10 is an example of a driving timing chart of the first embodiment.

FIG. 11 is a chart showing the differences of light emission waveforms of a display cell according to the differences of sustain pulse frequencies.

FIG. 12 is a circuit diagram of a second embodiment.

FIG. 13 is a chart schematically showing a relationship between the falling of a sustain pulse and the intensity of discharge light emission.

FIG. 14 is a circuit diagram of a third embodiment.

FIG. 15 is a circuit diagram of a fourth embodiment.

### DETAILED DESCRIPTION OF THE INVENTION

Next, an operation of the first embodiment will be described. An image signal supplied to the image processing part 101 is converted into data to be displayed on a plasma display panel with respective to each of the subfields in the subfield control part 102 within the image processing part 101. Then, from the display data for the respective subfields, the subfield-by-subfield display load calculating part 103 calculates display load amount allocated to each of the subfields. Based on data of the display load amount, the sustain frequency calculating part 104 calculates optimum frequencies for the respective subfields. The sustain frequency controller 106 within the driver controller 105 generates sustain pulse voltage data based on the sustain frequency for each of the subfields. The driver controller 105 supplies a sustain pulse waveform based on the sustain frequency for the respective subfields generated in the sustain frequency controller 106 to the scanning electrode driver 107 and the sustain electrode driver 108, and the scanning electrode driver 107 and the sustain electrode driver 108 are driven. The scanning electrode driver 107 and the sustain electrode driver 108 apply a sustain pulse voltage to the plasma display panel based on the received sustain pulse waveform.

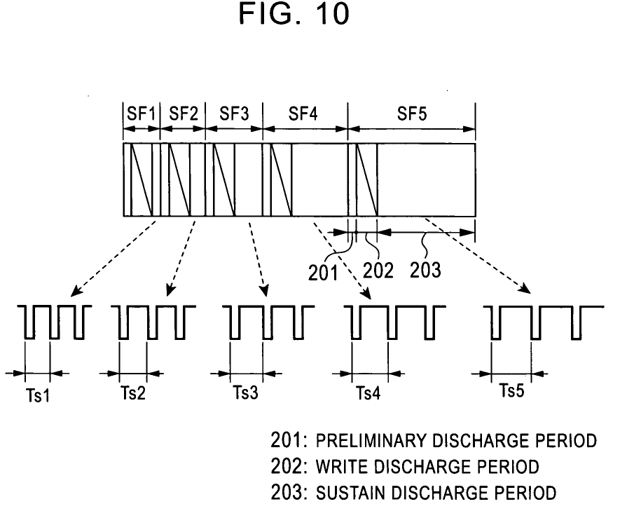

An example of a driving timing chart of the first embodiment is shown in FIG. 10. A subfield is made up of a preliminary discharge period 201, a write discharge period 202, and a sustain discharge period 203. In the example shown in FIG. 10, a field is composed of five subfields from subfield 1 to subfield 5. Depending on display load amount in the respective subfields, sustain pulses have sustain pulse intervals of Ts1 to Ts5. It should be noted that the term “sustain pulse interval” is equal to a half of a sustain frequency.

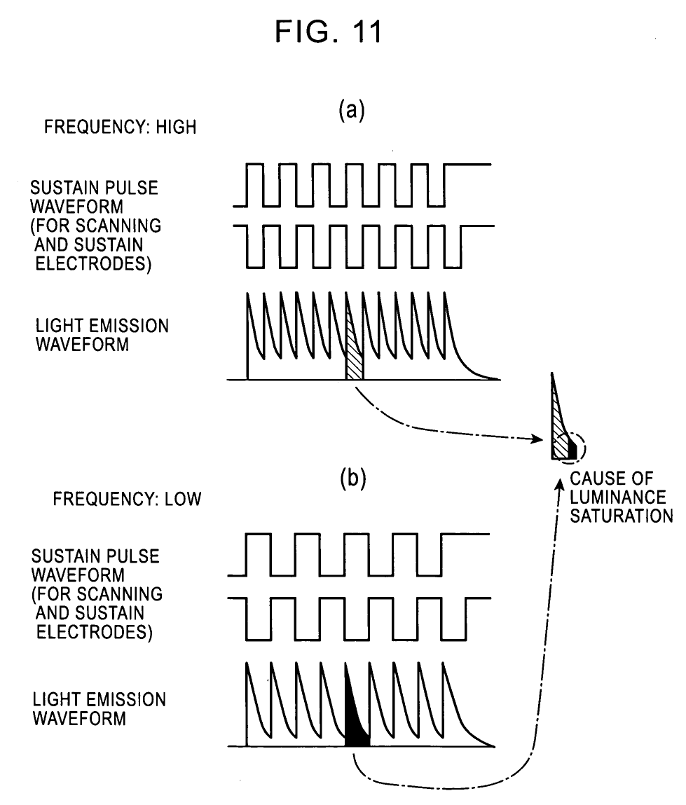

Luminance obtained from repeated discharges become the higher as a discharge interval between the n-th and the n+1-th light emissions is the longer. As shown in FIG. 11, this is because when a sustain frequency is high, a next light emission occurs in the persistence of a previous light emission, and luminance per light emission decreases because of the greatness of overlapping portion. By lowering a frequency of a sustain pulse, an interval between the n-th and the n+1-th discharges is lengthened. Luminance obtained in this way is higher than that produced by a sustain pulse whose frequency is not lowered, on condition that the number of discharges is the same.

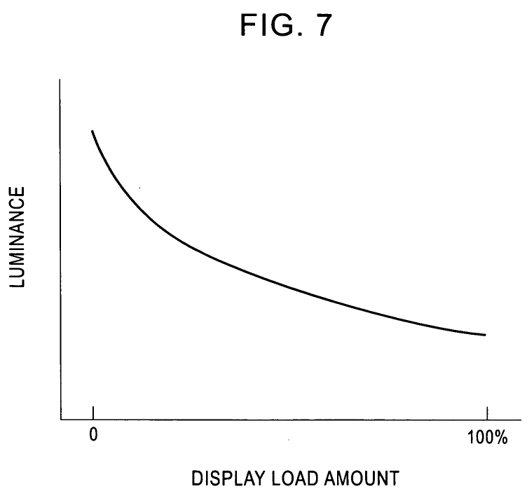

In conventional methods of driving a PDP, as shown by a solid line in FIG. 7, luminance of light emission fluctuates correspondingly to the display load amount per line, and therefore, the display quality is degraded. However, in this embodiment, when display load is heavy, frequency of the sustain pulse is lowered to compensate for the decreased luminance, and when display load is light, frequency of the sustain pulse is raised to prevent luminance from increasing. Therefore, the variances in luminance corresponding to the display load amount can be compensated for by changing the frequency of the sustain pulse. In this way, in this embodiment the display load amount for the respective subfields is calculated, the sustain frequency is changed correspondingly to the display load amount for the respective subfields, and thereby the variances in luminance can be accurately suppressed.

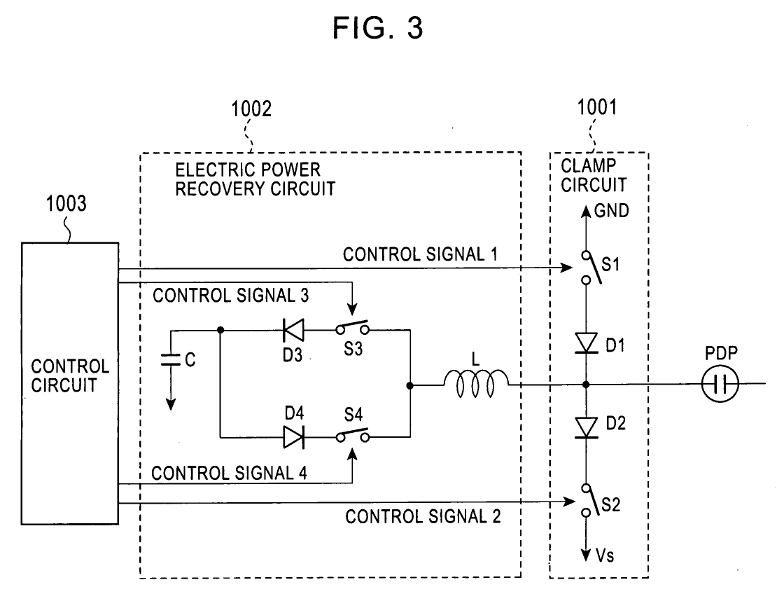

The sustain frequency for the respective subfields according to the display load amount can be calculated through an operation based on light emission waveforms as shown in FIG. 3.

According to the method disclosed in the patent document 1, in which variances in luminance is compensated for by increasing or decreasing the number of sustain pulses correspondingly to display load amount, a sustain pulse has only an integral value. Therefore, it is impossible to compensate for delicate luminance realized by one or less sustain pulse. Contrary to this, according to this embodiment, a frequency of a sustain pulse can be changed subfield by subfield at will. Therefore, even subtler luminance can be compensated for.

According to the method disclosed in the patent document 2, in which the time period from the beginning of an electric power recovery of a sustain pulse to the fixation of potentials of the scanning electrodes and the sustain electrodes at a sustain potential and the ground potential is changed, the probability of an erroneous discharge becomes high because of an overshoot which occurs when timing for fixing potentials of the scanning electrodes and the sustain electrodes at the sustain potential is too soon. Furthermore, an electric power recovery efficiency is reduced, and increased reactive power becomes significant. On the other hand, this embodiment enables compensation for variances in luminance without demerits such as deterioration in picture quality due to erroneous discharges, increase in consumption power because of increased reactive power, increase in cost caused by measures taken to cope with increased heat generation. At the same time as sustain frequencies can be changed with respect to each of the subfields, sustain frequencies of respective sustain pulses in the sustain periods of the respective subfields can be freely changed. Therefore, this embodiment also has an effect of reducing electromagnetic interference (EMI).

It should be noted that if the display load amount is calculated in each of the subfields with respect to each of the scanning electrodes, and the frequencies of the sustain pulses are dynamically changed and controlled with respect to each of the subfields correspondingly to the display load amount calculated in the respective subfields with respect to each of the scanning electrodes, accuracy of the compensation for variances in luminance can be improved. In this embodiment, the display load amount in the respective subfields may be calculated collectively with respect to plural lines of the sustain electrodes. In this case, a control circuit can be simplified to some extent. Or otherwise, in this embodiment, the display load amount in the respective subfields may be calculated collectively with respect to all of the scanning electrodes. Here, a control circuit can be simplified to a large extent.

The sustain frequency calculating part 104 may be a storage element such as a ROM which prestores data of the sustain frequencies to the respective counted numbers of the display load amount. This will speed the calculation the sustain frequencies.

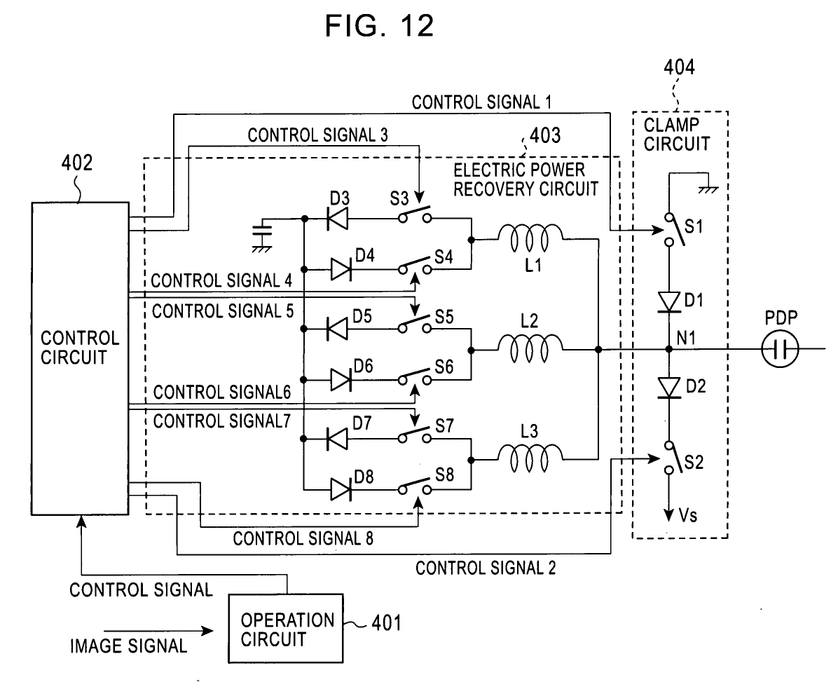

Next, a second embodiment of the present invention will be described. FIG. 12 is a circuit diagram of the second embodiment.

This embodiment has more than two electric power recovery circuits which have recovery coils having different inductances. FIG. 12 shows a case where three electric power recovery circuits are provided. A clamp circuit 404 has switches S1 and S2 and diodes D1 and D2. An connection point N1 of an output terminal of the diode D1 and an input terminal of the diode D2 is connected to a PDP. The connection point N1 is also connected to coils L1 to L3 of an electric power recovery circuit part 403. The switch S1 connects the ground potential and an input terminal of the diode D1, and the switch S1 switches on or off the connection between the input terminal of the diode D1 and the ground potential. The switch S2 connects a sustain potential and an output terminal of the diode D2, and the switch S2 switches on or off the connection between the output terminal of the diode D2 and the sustain potential. A operation circuit 401 calculates display load amount based on a received image signal, and the operation circuit 401 supplies a corresponding control signal to a control circuit 402. The control circuit 402 supplies control signals 3 to 8 which correspond to a control signal supplied from the operation circuit, switches on or off the switches 3 to 8, and determines which circuit to operate out of the electric power recovery circuits. The control circuit 402 also supplies control signals 1 and 2 corresponding to a time period when a recovery current flows, so as to control timing to turn on the switches 1 and 2 in the clamp circuit 404, when switching among the circuits having different inductances in the electric power recovery circuit 403.

Next, an operation of the present embodiment will be described. When an image signal is sent to the calculating circuit 401, the calculating circuit 401 calculates a display load amount based on the image signal, and supplies a control signal corresponding to the display load amount to the control circuit 402. Based on the control signal sent from the calculating circuit 401, the control circuit 402 supplies control signals 3 to 8. Based on the control signals 3 to 8 sent from the control circuit 402, the switches 3 to 8 are turned on or off. By the on-off operation of the switches 3 to 8 it is controlled which circuit to operate out of the electric power recovery circuits. Here, it is possible to operate more than two electric power recovery circuits in combination. Thus, it is possible to change the number of coils connected in parallel. Therefore, the inductance of the electric power recovery circuit part 403 can be switched, and the time period when a recovery current flows can be changed. This enables to change rising and falling time of a sustain pulse. The control circuit 402 also supplies control signals 1 and 2 corresponding to a time period when a recovery current flows, so as to control timing to turn on the switches 1 and 2 in the clamp circuit 404, when switching among the circuits having different inductances in the electric power recovery circuit 403.

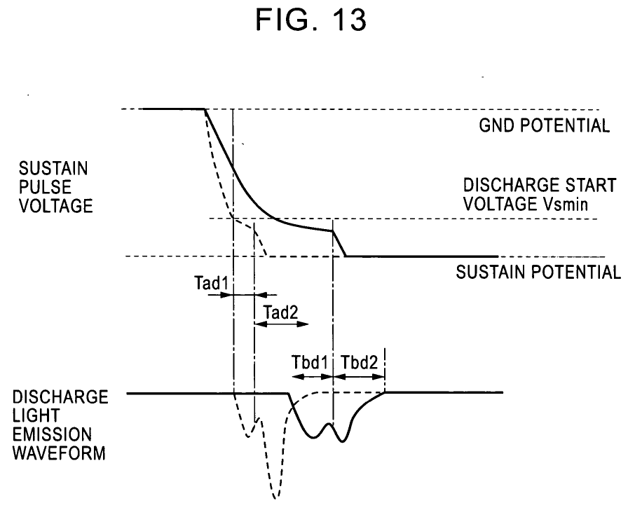

Referring to FIG. 13 it will be described how it becomes possible to control luminance per a pulse by controlling falling time of a sustain pulse. FIG. 13 schematically shows a relationship between falling of a sustain pulse and intensity of discharge light emission. A solid line shows a case where the inductance of the electric power recovery circuit is large, and a dashed line shows a case where the inductance of the electric power recovery circuit is small.

In a sustain discharge operation, a voltage amplitude of the sustain pulse (here, a voltage Vs, which is a difference between the ground potential and a sustain potential of a scanning electrode and a sustain electrode) is generally determined allowing for more than a certain amount of margin with respect to a discharge start voltage Vsmin. Therefore, a discharge begins when a recovery current is being displaced in the electric power recovery circuit. However, although a sustain discharge has already started, the sustain discharge cannot develop into a strong discharge, because the electric power recovery circuit has a high impedance. The sustain discharge can grow into a strong discharge only after the clamp circuit having a low impedance are switched on later.

Here, when the inductance of the electric power recovery circuit is small and a rising time of a sustain pulse is short, as shown in a period Tad1 in FIG. 13, a time period when a discharge current flows is short and the amount of wall charges accumulated in this time period is small. Accordingly, a discharge which occurs in a period Tad2 after the clamp circuit is switched on, can grow into a discharge strong enough. On the other hand, when the inductance of the electric power recovery circuit is large and a falling time of a sustain pulse is long, as shown in a period Tbd1 in FIG. 13, a time period when a discharge current flows is long and the amount of wall charges accumulated in this time period is large. These wall discharges reduce an effective voltage applied to a cell at an application of a sustain pulse. Therefore, a sustain discharge produced in a period Tbd2 cannot develop into a discharge strong enough.

Because of such mechanism, when the inductance of the electric power recovery circuit is small, luminance per a cycle of a sustain pulse is high, and on the contrary when the inductance of the electric power recovery circuit is large, luminance per a cycle of a sustain pulse is low. Thus, by controlling the inductance of the electric power recovery circuit according to variances in luminance due to display load, luminance per a cycle of a sustain pulse can be controlled, and thereby display quality can be improved.

By a method as described in the patent document 2, in which the time period from the beginning of an electric power recovery to the fixation at a sustain potential and the ground potential is changed, similar effects can be achieved. However, in that case, if the time period from the beginning of an electric power recovery to the fixation at a sustain potential and the ground potential is set shorter than the time period an electric power recovery current flows, in order to raise luminance per a cycle of a sustain pulse, the sustain pulse voltage is fixed at the sustain potential and the ground potential before the electric power recovery is completed. Therefore, the method has such demerits as increase in consumption power because of increased reactive power, increase in heat generation in the driver circuits, and increase in cost caused by measures taken to cope with the increased heat such as reinforcement of a cooling structure and an increase in the number of parallel-connected elements for reducing resistance components in the circuit. As a result cost is boosted.

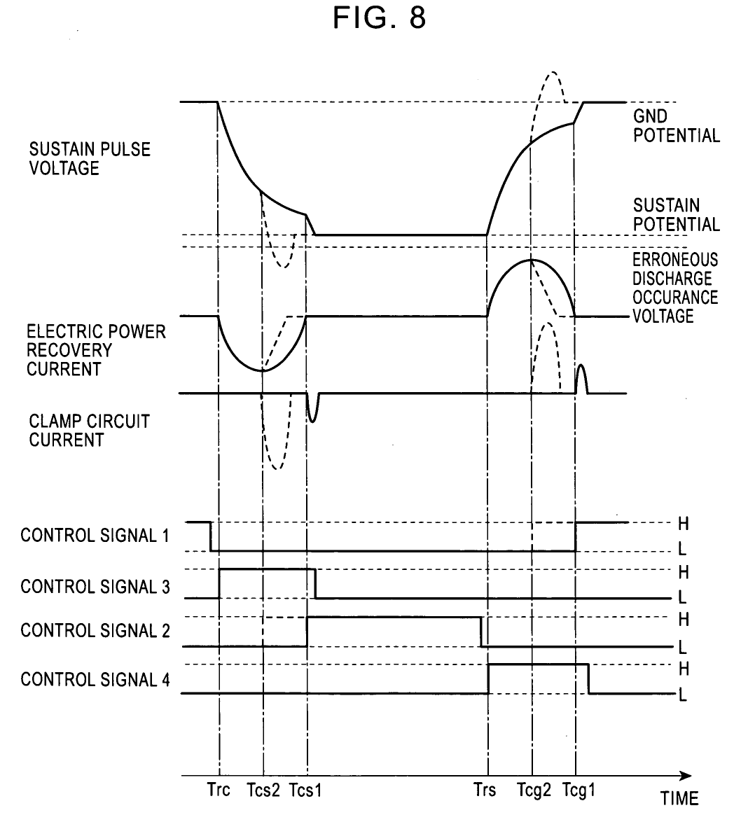

Besides, if the sustain pulse voltage is fixed at the sustain potential and the ground potential by the clamp circuit before the electric power recovery is completed, as shown in FIG. 8, an amount of current displaced by the clamp circuit becomes large, and a peak value of the displacement current at the clamp circuit is raised, and thus, an overshoot and an undershoot occur because of parasitic inductance of the driver circuits or the panel. Here, a peak voltage exceeds a discharge start voltage Vsmax of cells to which a write operation has not been conducted, and erroneous discharges occur. Another problem the method has is that, since these discharges are not according to display data, picture quality is degraded.

To the contrary, in the second embodiment, the sustain pulse voltage is always fixed at the sustain potential and the ground potential after the electric recovery is completed. Therefore, reactive power is not increased, and no overshoot or undershoot occurs. Thus, a PDP which is low cost and has improved picture quality can be provided.

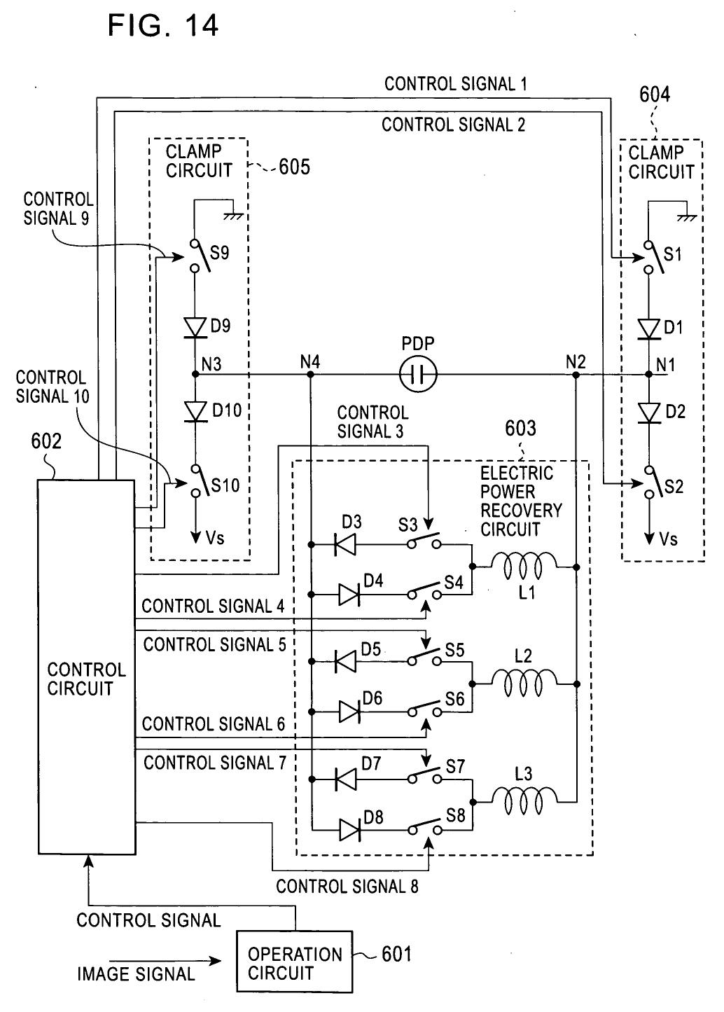

Next, a third embodiment of the present invention will be described. FIG. 14 is a circuit diagram showing the third embodiment. The circuit of this embodiment employs a self-recovery method as an electric power recovery system. Similar to the second embodiment, the embodiment is equipped with a plurality of electric power recovery circuits, and therefore, similar effect as that of the second embodiment can be obtained from this electric power recovery method.

Similar to the second embodiment, this embodiment has more than two electric power recovery circuits which have recovery coils having different inductances. FIG. 14 shows a case where three electric power recovery circuits are provided. A clamp circuit 604 has switches S1 and S2 and diodes D1 and D2. An connection point N1 of an output terminal of the diode D1 and an input terminal of the diode D2 is connected to a PDP. A connection point N2, which connects the connection point N1 and the PDP, is connected to coils L1 to L3 of an electric power recovery circuit part 603. The switch S1 connects the ground potential and an input terminal of the diode D1, and the switch S1 switches on or off the connection between the input terminal of the diode D1 and the ground potential. The switch S2 connects a sustain potential Vs and an output terminal of the diode D2, and the switch S2 switches on or off the connection between the output terminal of the diode D2 and the sustain potential Vs. A clamp circuit 605 has switches S9 and S10 and diodes D9 and D10. A connection point N3, which connects an output terminal of the diode D9 and an input terminal of the diode D10, is connected to the PDP. A connection point N4, which connects the connection point N3 and the PDP, is connected to diodes D3 to D8 of the electric power recovery circuit part 603. The switch S1 connects the ground potential and an input terminal of the diode D1, and the switch S1 switches on or off the connection between the input terminal of the diode D1 and the ground potential. The switch S2 connects a sustain potential and an output terminal of the diode D2, and the switch S2 switches on or off the connection between the output terminal of the diode D2 and the sustain potential Vs. An operation circuit 601 calculates display load amount based on a received image signal, and the operation circuit 601 supplies a corresponding control signal to a control circuit 602. The control circuit 602 supplies control signals 3 to 8 which correspond to a control signal supplied from the operation circuit, switches on or off the switches 3 to 8, and determines which circuit to operate out of the electric power recovery circuits. The control circuit 602 also supplies control signals 1 and 2 corresponding to a time period when a recovery current flows, so as to control timing to turn on the switches S1 and S2, and switches S9 and S10 in the clamp circuits 604 and 605, when switching among the circuits having different inductances in the electric power recovery circuit 603.

Next, an operation of the present embodiment will be described. When an image signal is sent to the operation circuit 601, the operation circuit 601 calculates a display load amount based on the image signal, and the operation circuit 601 supplies a control signal corresponding to the image signal to the control circuit 602. Based on the control signal sent from the operation circuit 601, the control circuit 602 supplies control signals 3 to 8. Based on the control signals 3 to 8 sent from the control circuit 602, the switches 3 to 8 are turned on or off. By the on-off operation of the switches 3 to 8, it is controlled which circuit to operate out of the electric power recovery circuits. Here, it is possible to operate more than two circuits in combination out of the electric power recovery circuits. Thus, it is possible to change the number of coils connected in parallel. Therefore, the inductance of the electric power recovery circuit part 603 can be switched, and the time period during which the recovery current flows can be changed. This enables to change rising and falling time periods of the sustain pulse. The control circuit 602 also supplies control signals 1 and 2 corresponding to a time period when a recovery current flows, so as to control timing to turn on the switches S1 and S2, and switches S9 and S10 in the clamp circuits 604 and 605, when switching among the circuits having different inductances in the electric power recovery circuit 603.

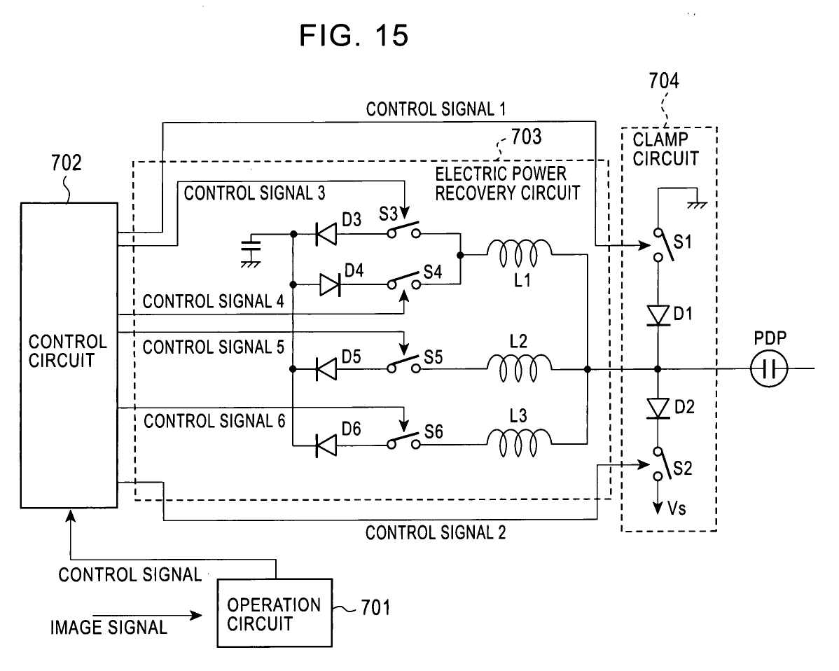

Next, a fourth embodiment of the present invention will be described. FIG. 15 is a circuit diagram of the fourth embodiment. This circuit was devised in view of the fact that a sustain discharge is produced only in the falling time period of a sustain pulse. During the time period when the sustain pulse falls, the inductance of the coil is set variable, so that the time period when the sustain pulse falls can be changed. During the time period when the sustain pulse rises, when the sustain discharge do not occur, the inductance of the coil is fixed, so that the time period when the sustain pulse rises can be fixed. This circuit can produce a quite similar effect as that of the second embodiment. At the same time, the number of the circuits used in the device can be reduced, and thereby the increase in cost can further be suppressed.

Similar to the first embodiment, in the second to fourth embodiments, too, by calculating the display load amount in the respective subfields with respect to each line of the scanning electrodes, and controlling the frequency of the sustain pulse by changing the frequency of the sustain pulse dynamically with respect to the respective subfields based on the display load amount calculated in the respective subfields with respect to each line of the scanning electrodes, the accuracy of compensation for the variances in luminance can be improved. The display load amount in the respective subfields may be calculated collectively with respect to plural lines of the scanning electrodes. In this case, the control circuit can be simplified to some extent. Or otherwise, the display load amount in the respective subfields may be calculated collectively with respect to all lines of the scanning electrodes. In this case, the control circuit can be simplified to a large extent.

This application is based on Japanese Patent Application No. 2004-78919 which is hereby incorporated by reference.

1. A plasma display device comprising:
a display part made of a plurality of display cells arranged in a matrix,
a plurality of scanning electrodes respectively connected to the display cells of a row direction,
a plurality of sustain electrodes respectively connected to the display cells of a row direction,
a plurality of data electrodes respectively connected to the display cells of a column direction,
a scanning electrode driver for applying a voltage to the scanning electrodes,
a sustain electrode driver for applying a voltage to the sustain electrodes,
a data electrode driver for applying a voltage to the data electrodes,
a first processing part which converts an image signal into display data to be displayed on a plasma display panel with respect to each of the display cells, and allocates the display data to respective subfields which constitutes a field of a display period,
a second processing part which calculates display load amount for the respective subfields based on the display data allocated to each of the subfields with respect to the respective display cells,
a third processing part which calculates a sustain frequency of a sustain pulse to be applied in periods of the respective subfields based on the display load amount for the respective subfields,
a sustain frequency controller which generates a sustain pulse waveform to be applied to the respective subfields based on the sustain frequency of the sustain pulse to be applied in the periods of the respective subfields; and
a drive controller which supplies the sustain pulse waveform to the scanning electrode driver and the sustain electrode driver.

2. The plasma display device according to claim 1, wherein the third processing part calculates the sustain frequency of the sustain pulse based on sustain waveform data per sustain frequency at the time of discharges produced in the display cells.

3. The plasma display device according to claim 1, wherein the third processing part calculates the sustain frequency of the sustain pulse based on data of a relationship between sustain frequencies of sustain pulses and display load amount prestored in a storage element.

4. A plasma display device comprising:
a display part made of a plurality of display cells arranged in a matrix,
a plurality of scanning electrodes respectively connected to the display cells of a row direction,
a plurality of sustain electrodes respectively connected to the display cells of a row direction,
a plurality of data electrodes respectively connected to the display cells of a column direction,
a scanning electrode driver for applying a voltage to the scanning electrodes,
a sustain electrode driver for applying a voltage to the sustain electrodes,
a data electrode driver for applying a voltage to the data electrodes,
an electric power recovery circuit for generating a sustain pulse, inductance of the electric power recovery circuit being changeable,
a first processing part which converts an image signal into display data to be displayed on a plasma display panel with respect to each of the display cells, and allocates the display data to respective subfields which constitutes a field of a display period,
a second processing part which calculates display load amount for the respective subfields based on the display data allocated to each of the subfields with respect to the respective display cells; and
a control circuit for changing the inductance of the electric power recovery circuit based on the calculation results of the second processing part.

5. The plasma display device according to claim 4, wherein the electric power recovery circuit includes a plurality of coils having different inductances, and selects and uses one or more than two of the coils.

6. The plasma display device according to claim 5, wherein the plasma display device has one or two clamp circuits.

7. The plasma display device according to claims 1 to 6, wherein the second processing part calculates display load amount for the respective subfields with respect to each line of the sustain electrodes.

8. The plasma display device according to claims 1 to 6, wherein the second processing part calculates display load amount for the respective subfields with respect to plural lines of the sustain electrodes.

9. The plasma display device according to claims 1 to 6, wherein the second processing part calculates display load amount for in the respective subfields as a sum of display load amount of all lines of the sustain electrodes.

10. A method of driving a plasma display device including a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, the method comprising:
a first step for converting an image signal into display data to be displayed on a plasma display panel with respect to each of the display cells, and allocating the display data to respective subfields which constitutes a field of display period,
a second step for calculating display load amount for the respective subfields based on the display data allocated to each of the subfields with respect to the respective display cells,
a third step for calculating a sustain frequency of a sustain pulse to be applied in periods of the respective subfields based on the display load amount for the respective subfields,
a fourth step for generating a sustain pulse waveform to be applied to the respective subfields based on the sustain frequency of the sustain pulse to be applied in the periods of the respective subfields; and
a fifth step for supplying the sustain pulse waveform to the scanning electrode driver and the sustain electrode driver.

11. A method of driving the plasma display device according to claims 10, wherein the third step is a step for calculating the sustain frequency of the sustain pulse based on sustain waveform data per sustain frequency at the time of discharges produced in the display cells.

12. A method of driving the plasma display device according to claims 10, wherein in the third step the sustain frequency of the sustain pulse is calculated based on data of a relationship between sustain frequencies of sustain pulses and display load amount prestored in a storage element.

13. A method of driving a plasma display device including a display part made of a plurality of display cells arranged in a matrix, a plurality of scanning electrodes respectively connected to the display cells of a row direction, a plurality of sustain electrodes respectively connected to the display cells of a row direction, a plurality of data electrodes respectively connected to the display cells of a column direction, a scanning electrode driver for applying a voltage to the scanning electrodes, a sustain electrode driver for applying a voltage to the sustain electrodes, a data electrode driver for applying a voltage to the data electrodes, an electric power recovery circuit for generating a sustain pulse, inductance of the electric power recovery circuit being changeable, the method comprising:
a first step for converting an image signal into display data to be displayed on a plasma display panel with respect to each of the display cells, and allocating the display data to the respective subfields which constitutes a field of display period,
a second step for calculating display load amount for the respective subfields based on the display data allocated to each of the subfields with respect to the respective display cells,
a third step for changing the inductance of the electric power recovery circuit based on the display load amount for the respective subfields.

14. A method of driving the plasma display device according to claims 13, wherein the electric power recovery circuit includes a plurality of coils having different inductances, and the third step is a step in which one or more than two of the coils of the electric power recovery circuit are selected and used.

15. A method of driving the plasma display device according to claims 10 to 14, wherein the second step is a step in which display load amount for the respective subfields is calculated with respect to each line of the sustain electrodes.

16. A method of driving the plasma display device according to claims 10 to 14, wherein the second step is a step in which display load amount for the respective subfields is calculated with respect to plural lines of the sustain electrodes.

17. A method of driving the plasma display device according to claims 10 to 14, wherein the second step is a step in which display load amount for the respective subfields calculated as a sum of display load amount of all lines of the sustain electrodes.
